(19) United States
(12) Patent Application Publication
(10) Pub. No.: US 2024/0377119 A1
(43) Pub. Date: Nov. 14, 2024

(54) GOLF CART COOLER ASSEMBLY

(71) Applicant: Edward MAURO, Oldsmar, FL (US)

(72) Inventor: Edward MAURO, Oldsmar, FL (US)

(21) Appl. No.: 18/144,300

(22) Filed: May 8, 2023

(51) Int. Cl. F25D 11/00

(52) U.S. Cl. CPC F25D 11/003; F25D 2201/10

(57) ABSTRACT

A golf cart cooler for a golf cart includes an insulated container configured to fit within a rear compartment of a golf cart, a lid secured to the insulated container and configured to provide access to an interior of the insulated container, at least one sliding rail having an extendable portion and a stationary portion, and at least one support bracket configured to be secured within the rear compartment to the golf cart. The extendable portion of the at least one sliding rail is secured to a bottom portion of the insulated container and the stationary portion is secured to the at least one support bracket so that the insulated container can be slid out from the rear compartment and accessed.

### FIELD OF THE INVENTION

The present invention relates to the field of coolers, and, more particularly, to golf cart cooler assembly.

### BACKGROUND OF THE INVENTION

Golf is often played in hot weather conditions and golf carts typically do not have much room for storing items in coolers to keep food and beverages cool. For example, one type of golf cart cooler attaches either to the inner front of the cart's body within the passenger compartment or the outer front face of the cart. Another example of a cooler is designed to fit inside of the golf cart between the passenger seating compartment and the golf bag storage area. A disadvantage to this cooler is that the cooler is limited in size.

### SUMMARY OF THE INVENTION

A golf cart cooler assembly for a golf cart is disclosed. The golf cart cooler assembly includes an insulated container configured to fit within a rear compartment of a golf cart, a lid secured to the insulated container and configured to provide access to an interior of the insulated container, at least one sliding rail having an extendable portion and a stationary portion, and at least one support bracket configured to be secured within the rear compartment to the golf cart. The extendable portion of the at least one sliding rail is secured to a bottom portion of the insulated container and the stationary portion is secured to the at least one support bracket so that the insulated container can be slid out from the rear compartment and accessed.

The at least one sliding rail may comprise two sliding rails where a first sliding rail is secured along a first bottom edge of the insulated container and a second sliding rail is secured along an opposing second bottom edge of the insulated container. The at least one support bracket may comprise a first support bracket secured to the first sliding rail and a second support bracket secured to the second sliding rail, where the sliding rails are configured to move between a retracted position and an extended position.

In addition, the sliding rails may have a locking pull handle to toggle between locking the sliding rail in the retracted position and the extended position. Also, the insulated container may have a removable liner and the lid may be removable. The lid may also include an automated light configured to turn on when the lid is opened, and to turn off when the lid is closed. The insulated container may also have a lock to secure the lid to the insulated container and the support brackets may include a height adjustment mechanism to account for variations in different sizes and shaped of the rear compartments of golf carts.

In another particular aspect, a method of using a golf cart cooler assembly is disclosed. The golf cart cooler assembly includes an insulated container having a lid configured to provide access to an interior of the insulated container, with at least one sliding rail having an extendable portion and a stationary portion, and at least one support bracket secured within a rear compartment of a golf cart, where the extendable portion of the at least one sliding rail is secured to a bottom portion of the insulated container and the stationary portion is secured to the at least one support bracket. The method includes pulling a locking tab handle on the at least one sliding rail to move the at least one sliding rail from the retracted position to the extended position to access the interior of the insulated container. The method may also include removing the lid.

### BRIEF DESCRIPTION OF THE DRAWINGS

FIG. 1 is a perspective view of a golf cart cooler assembly in accordance with the present invention installed in a rear compartment of a golf cart;

FIG. 2 is a perspective view of the golf cart cooler assembly of FIG. 1 with a lid open and an insulated container in an extended position;

FIG. 3 is a perspective view of the golf cart cooler assembly;

FIG. 4 is a front elevational view of the golf cart cooler assembly;

FIG. 5 is a cross sectional view taken along the lines 5-5 of FIG. 4;

FIG. 6 is a bottom view of the golf cart cooler assembly;

FIG. 7 is a perspective view of a sliding rail of the golf cart cooler assembly; and

FIG. 8 is a perspective view of the opposing side of the sliding rail shown in FIG. 7.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

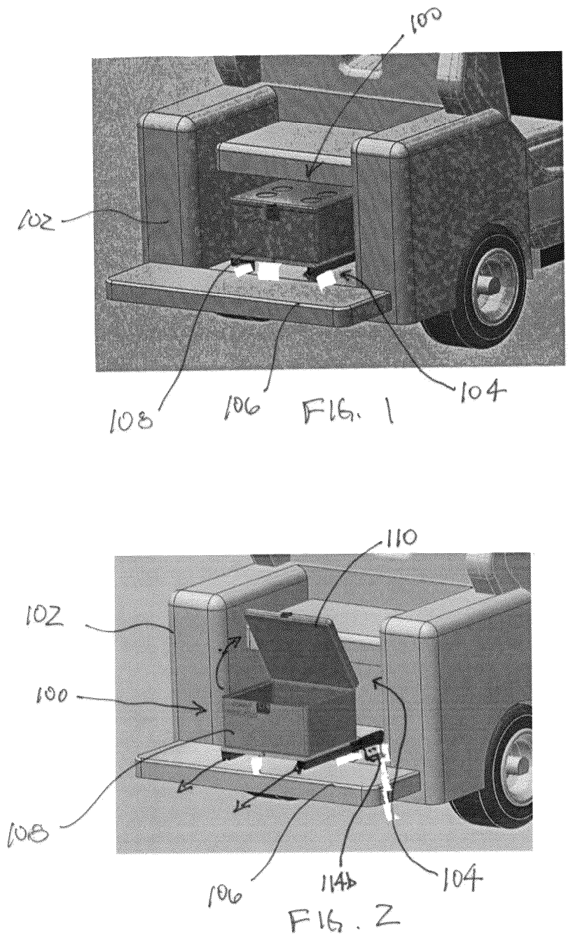

Referring initially to FIGS. 1 and 2, a golf cart cooler assembly is shown and generally designated 100. The golf cart cooler assembly 100 is mounted within a rear compartment 104 of the golf cart 102. An insulated container 108 of the golf cart cooler assembly 100 is supported by sliding rails that allow the insulated container 108 to be pulled out and accessed as shown in FIG. 2.

A support bracket 114a can be seen in FIG. 2 that is secured to a floor of the rear compartment 104. The support bracket 114a supports the sliding rails at a height sufficient to clear a rear footstep 106 extending from a rear of the golf cart 102. A lid 110 can be lifted to access an interior of the insulated container 108.

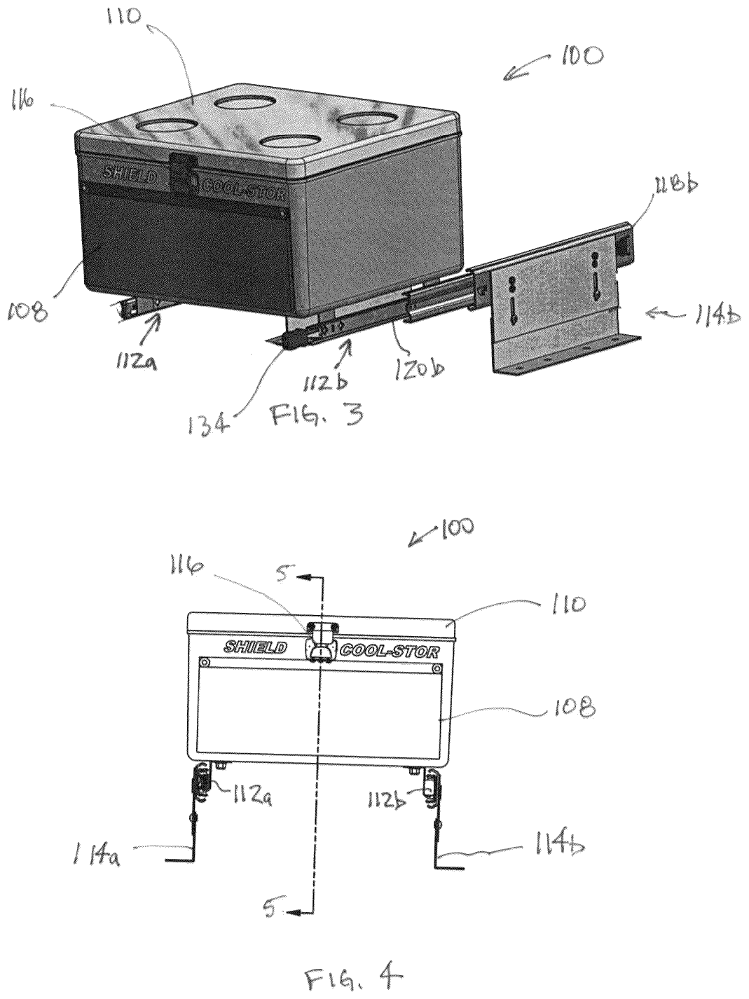

The golf cart cooler assembly 100 is shown in FIG. 3 without the golf cart 102 for clarity. The sliding rails 112a, 112b are shown secured under the insulated container 108 on opposing portions. Preferably the sliding rails 112a, 112b are mounted parallel to one another. As those of ordinary skill in the art can appreciate, there may only be one sliding rail proximate a centerline to support the insulated container 108, or the sliding rails may be mounted to opposing vertical sides of the insulated container 108, or on the top of the insulated container 108.

The insulated container 108 includes a lid 110 that can be lifted to access an interior of the insulated container 108. The interior of the insulated container 108 can be used to store food and beverages. A lock 116, such as a combination lock, may be used to secure the lid 110 to the insulated container 108 to prevent unauthorized access. In addition, indents on the lid 110 may be used to secure drinks.

Referring now to FIGS. 3 and 4, each of the sliding rails 112a, 112b comprise a respective stationary portion 118a, 118b that is secured to the support bracket 114a, 114b. A respective extendable portion 120a, 120b slides out from the stationary portion 118a, 118b. The insulated container 108 is secured to the extendable portions 120a, 120b so that it can be moved from being within the rear compartment 104 where it is protected, to being moved outwards to be accessed. The extendable portions 120a, 120b may comprise two or more telescoping sections.

As explained above, a pair of slidable rails 112a, 112b are secured to the bottom of the insulated container 108. A pair of support brackets 114a, 114b are secured to the golf cart 102 to support the respective slidable rails 112a, 112b, which in turn support the insulated container 108.

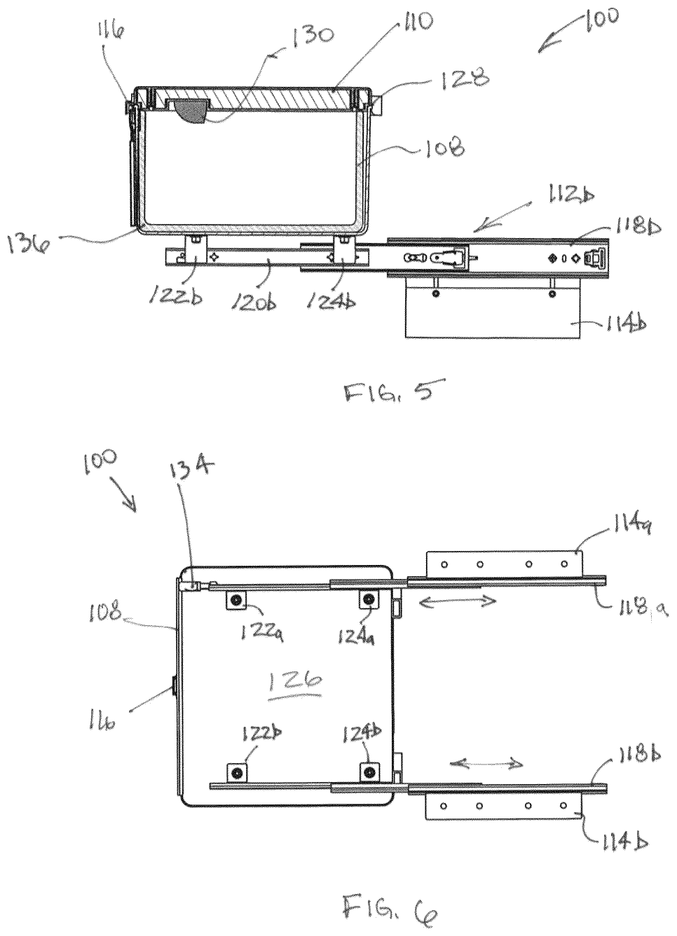

Referring now to FIG. 5, a cross sectional view of the golf cooler assembly 100 taken along the line 5-5 in FIG. 4 is shown. The insulated container 108 may include a removable liner 136 in order to create more available interior space. The telescoping configuration of the slidable rail 122b is also visible. The stationary portion 118b and the extendable portion 120b is shown in the extended position. A front tab 122b and a rear tab 124 are used to secure the insulated container 108 to the extendable portion 120b of the slidable rail 112b.

The lid 110 may be insulated and be secured to the insulated container 108 along a rear edge by a hinge 128. The lid 110 may also be completely removable. In addition, a light 130, such as an LED light for example, may be secured within the lid 130 to illuminate the interior of the insulated container 108. The light 130 is configured to automatically turn on when the lid 110 is opened.

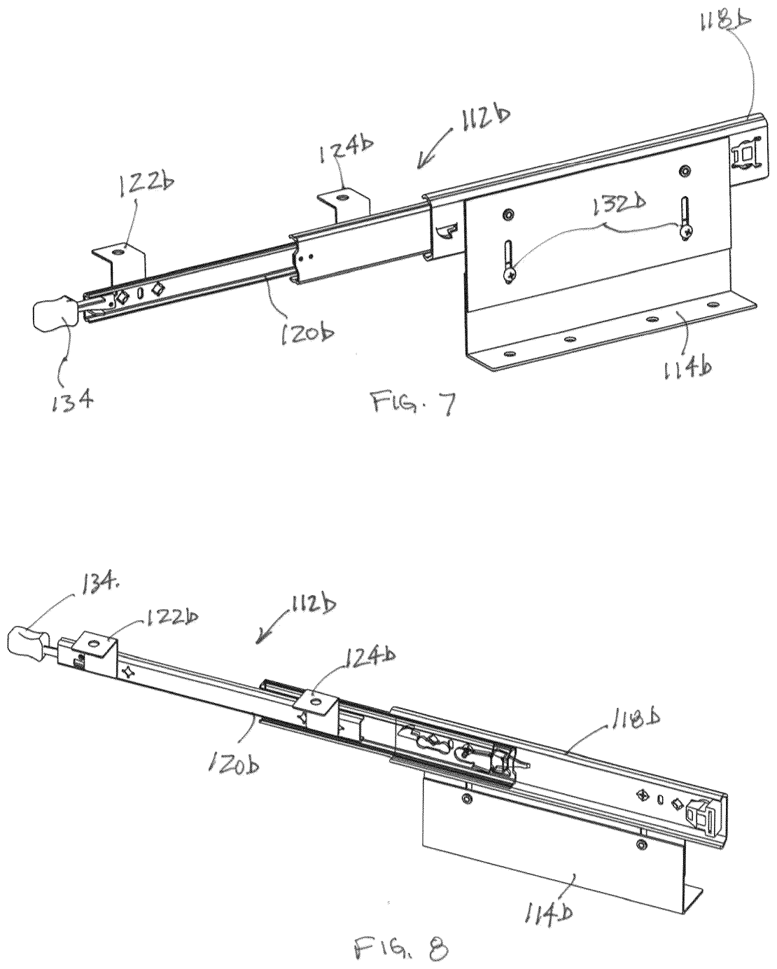

The golf cart cooler assembly 100 also includes a locking pull handle 134 to selectively engage locking the sliding rail 112b in either the retracted position or the extended position as best shown in FIGS. 6 and 7. The locking pull handle 134 is mounted to a free end of the extended portion 120b of the sliding rail 112b. The locking pull handle 134 prevents the extended portion 120b of the sliding rail 112b from moving. Accordingly when the extended portion 120b is extended outward, the locking pull handle 134 engages and prevents the extended portion 120b from sliding back into the stationary portion 118b. Similarly, when the extended portion 120b is retracted into the stationary portion 118, the locking pull handle 134 engages and prevents the extended portion 120b from sliding out of the stationary portion 118b. In addition, the support brackets 114a, 114b may include a height adjustment mechanism 132b that includes vertically aligned slots and respective bolts. Thus, the height of the slidable rails 112a, 112b can be adjusted relative to the bottom of the rear compartment 104 of the golf cart 102 by loosening the bolts and sliding a top half of the support bracket 114b up or down. Although one support bracket 114b is shown in FIGS. 7 and 8 for exemplary purposes, both support brackets 114a, 114b have the height adjustment mechanism in order to level the insulated container 108.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A golf cart cooler comprising:
an insulated container configured to fit within a rear compartment of a golf cart;
a lid secured to the insulated container and configured to provide access to an interior of the insulated container;
at least one sliding rail having an extendable portion and a stationary portion; and
at least one support bracket configured to be secured within the rear compartment to the golf cart;
wherein the extendable portion of the at least one sliding rail is secured to a bottom portion of the insulated container and the stationary portion is secured to the at least one support bracket so that the insulated container can be slid out from the rear compartment and accessed.

2. The golf cart cooler of claim 1, wherein the at least one sliding rail comprises a first sliding rail secured along a first bottom edge of the insulated container and a second sliding rail secured along an opposing second bottom edge of the insulated container.

3. The golf cart cooler of claim 2, wherein the at least one support bracket comprises a first support bracket secured to the first sliding rail and a second support bracket secured to the second sliding rail.

4. The golf cart cooler of claim 1, wherein the at least one sliding rail is configured to move between a retracted position and an extended position.

5. The golf cart cooler of claim 4, wherein the at least one sliding rail has a locking pull handle to toggle between locking the at least one sliding rail in the retracted position and the extended position.

6. The golf cart cooler of claim 1, wherein the insulated container has a removable liner.

7. The golf cart cooler of claim 1, wherein the lid is removable.

8. The golf cart cooler of claim 1, wherein the lid further comprising an automated light configured to turn on when the lid is opened, and to turn off when the lid is closed.

9. The golf cart cooler of claim 1, further comprising a lock to secure the lid to the insulated container.

10. The golf cart cooler of claim 1, wherein the at least one support bracket comprises a height adjustment mechanism.

11. A golf cart cooler comprising:
a container configured to fit within a rear compartment of a golf cart; and
at least one sliding rail;
wherein the container is secured to the at least one sliding rail and the sliding rail is secured to the golf cart so that the container can be slid out from the rear compartment and accessed.

12. The golf cart cooler of claim 11, further comprising a support bracket configured to be secured to the golf cart to support the at least one sliding rail, wherein the at least one sliding rail has an extendable portion and a stationary portion.

13. The golf cart cooler of claim 11, further comprising a lid secured to the container and configured to provide access to an interior of the container.

14. The golf cart cooler of claim 11, further comprising a liner removably secured inside the container.

15. The golf cart cooler of claim 11, wherein the at least one sliding rail comprises a first sliding rail secured to a first portion of the container and a second sliding rail secured to a second portion of the container.

16. The golf cart cooler of claim 15, further comprising a first support bracket to support the first sliding rail and a second support bracket to support the second sliding rail.

17. The golf cart cooler of claim 11, wherein the at least one sliding rail comprises an extendable portion and a stationary portion and is configured to move between a retracted position and an extended position.

18. The golf cart cooler of claim 17, wherein the at least one sliding rail has a locking pull handle to toggle between locking the at least one sliding rail in the retracted position and the extended position.

19. A method of using a golf cart cooler comprising an insulated container installed within a rear compartment of a golf cart, a lid secured to the insulated container and configured to provide access to an interior of the insulated container, at least one sliding rail having an extendable portion and a stationary portion, and at least one support bracket secured within the rear compartment to the golf cart, wherein the extendable portion of the at least one sliding rail is secured to a bottom portion of the insulated container and the stationary portion is secured to the at least one support bracket the method comprising:
pulling a locking tab handle on the at least one sliding rail to move the at least one sliding rail from the retracted position to the extended position to access the interior of the insulated container.

20. The method of claim 19, further comprising removing the lid.
